(19) United States
(12) Patent Application Publication
(10) Pub. No.: US 2010/0174616 A1
(43) Pub. Date: Jul. 8, 2010

(54) Method and System for Utilizing Purchase Upgrades for Purposes of Providing Humanitarian Aid

(75) Inventor: Robert Landures Steed, Springville, UT (US)

Correspondence Address: HOLME ROBERTS & OWEN, LLP, 299 SOUTH MAIN, SUITE 1800, SALT LAKE CITY, UT, 84111, US

(73) Assignee: Trivani International, LLC, Springville, UT (US)

(21) Appl. No.: 12/349,000

(22) Filed: Jan. 6, 2009

(51) Int. Cl. G06Q 30/00

(52) U.S. Cl. 705/26

(57) ABSTRACT

A system for processing transactions related to providing humanitarian aid. A database stores a plurality of identification codes for a plurality of upgraded items, each of which is available for purchase. The database also stores instructions for providing humanitarian aid in association with a purchase of an upgraded item. A receiver registers purchases of the upgraded item that includes an identification code for the upgraded item. A comparator is coupled to the receiver and the database for cross-referencing the database, using the identification code. In this manner, the comparator is capable of determining the corresponding instructions for a purchase of the upgraded item. In addition, an executor executes the instructions for purposes of providing humanitarian aid in association with a purchase of the upgraded item.

### CROSS REFERENCE TO RELATED APPLICATION

This patent application is related to the co-pending patent application Ser. No. ______, Attorney Docket Number 52957-10200, entitled “Method and System for Awarding Points for Purchases for Purposes of Providing Humanitarian Aid,” with filing date ______, and assigned to the assignee of the present invention, which is herein incorporated by reference in its entirety.

### BACKGROUND OF THE INVENTION

1. Field of invention

The present invention relates to the field of marketing of a purchasable item. Specifically, the present invention relates to providing of humanitarian aid in association with one or more purchases of an upgrade to a purchasable item.

2. The Relevant Technology

At the retail level, consumers are presented with a myriad of competing goods and services. Various marketing techniques are utilized to try to capture the attention of a consumer to purchase a particular good or service. For some companies, huge amounts of resources are spent in attracting a consumer in order to maintain and grow market share. For instance, a consumer in the market for a car is bombarded with advertising throughout various media, including television, internet, radio, print etc. to attract the consumer to purchase a particular make and type of car.

In addition, after-sale marketing is highly emphasized. That is, once the consumer is captured as a customer through a sale of a product provided by a particular manufacturer, retailer, or service provider, that consumer is likely to purchase additional products from the same manufacturer, retailer, or service provider. As such, the consumer may be targeted for after-sale marketing in an effort to pursue further selling opportunities.

However, focus on the consumer may be lacking during the in-between time period before a sale has been made, but after the consumer has made the decision to purchase from a particular manufacturer, retailer, or service provider. That is, focus on the consumer may diminish once the consumer has made the decision to purchase a particular good or service. While the consumer may be captured by the manufacturer, retailer, or service provider as being likely to make a purchase, efforts to make additional sales may be lacking.

A consumer that is located in the in-between time period can be a likely subject for further marketing. Fresh off the decision to purchase a product, the consumer is highly engaged in the process of purchasing not only a particular product of interest, but also additional items. That is, the consumer is still in the mood to buy.

### SUMMARY OF THE INVENTION

What is needed is an invention that provides marketing to consumers who are located in the decision making process between the time the consumer has made a decision to purchase, but before the actual purchase. What is described in the present invention is a method and system that takes advantage of the attention of a consumer who has made a decision to purchase to promote upgrades of those items for purchase. Specifically, the purchase of upgrades is associated with the provision of humanitarian aid.

In one embodiment, a method for providing humanitarian aid is described. An item for purchase is provided. The item is provided at a purchase price. Additionally, an upgrade to the item is provided, in the form of an upgraded item. That is, additional features are provided in the upgraded item. A purchase price of the upgraded item includes an upgrade cost, which is in addition to the purchase price. A purchase of the upgraded item is recognized. Specifically, it is recognized that a consumer has purchased the upgraded item. In association with the purchase of the upgraded item, humanitarian aid is provided.

In another embodiment, a system for processing transactions related to providing humanitarian aid is described. The system includes a database for storing a plurality of identification codes for a plurality of upgraded items, each of which is available for purchase. The database is also used for storing instructions providing humanitarian aid in association with a purchase of a corresponding upgraded item. The system includes a receiver for registering purchases of at least one purchase of an upgraded item that includes an identification code for the upgraded item. The upgraded item is an upgrade to an item provided for purchase at a first price, and wherein a purchase price of the upgraded item includes an upgrade cost. The system also includes a comparator coupled to the receiver and the database for cross-referencing the database, using the identification code. In this manner, the comparator is capable of determining the corresponding instructions for the at least one purchase of the upgraded item. In addition, an executor executes the instructions for purposes of providing humanitarian aid in association with the at least one purchase of the upgraded item.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a network of merchant outlets (e.g., retailers) or distribution avenues and a system that is capable of providing humanitarian aid through the purchase of upgrades to purchasable items, in accordance with one embodiment of the present invention.

FIG. 2 is flow diagram illustrating a method for providing humanitarian aid through the purchase of upgrades to purchasable items, in accordance with one embodiment of the present invention.

FIG. 3 is a block diagram of a contribution distributor that is capable of providing humanitarian aid through the purchase of upgrades to purchasable items, in accordance with one embodiment of the present invention.

FIG. 4 is a flow diagram illustrating a method for providing humanitarian aid as implemented, in part, by the contribution distributor of FIG. 3, in accordance with one embodiment of the present invention.

FIG. 5 is an illustration of a status report of a humanitarian aid program that implements humanitarian aid in association with a purchase of an upgraded item, in accordance with one embodiment of the present invention.

### DETAILED DESCRIPTION OF THE PREFERRED EMBODIMENTS

Reference will now be made in detail to the preferred embodiments of the present invention, a method and system for providing humanitarian aid through the purchase of upgrades for purchasable items. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for humanitarian aid through consumer transactions. Specifically, the provision of humanitarian aid is associated with the purchase by consumers of upgrades to items for purchase. In addition, embodiments of the present invention provide a means for marketing to consumers who are located in the decision making process in between the time the consumer has made a decision to purchase, but before the actual purchase. In this way, the present invention facilitates and promotes the purchase of upgrades at the time of purchase, when the consumer is already in a position to buy.

Embodiments of the present invention are described within the context of items for purchase and upgrades to the items of purchase. It is intended that the term “item” includes anything and everything that is or may be presented to a consumer for purchase. For instance, an “item” includes goods, commodities, services, a package of multiple goods, package of multiple services, and a packaged combination of goods and services.

In addition, while some embodiments of the present invention are described within the context of providing humanitarian aid in association with a purchase of an upgraded item, other embodiments are well suited to providing any type of aid in association with the purchase of the upgraded item. For example, a donation made as a result of a purchase of an upgraded item can be made to any charitable organization or program (e.g., animal shelter, scholarship fund, etc.). As such, the purchase of an upgraded item can be directly associated with the implementation of any type of benefit or contribution.

### 1. Notation and Nomenclature

Embodiments of the present invention can be implemented on software or dedicated hardware running on a computer system. The computer system can be a personal computer, notebook computer, server computer, mainframe, networked computer, handheld computer, personal digital assistant, workstation, and the like. This software or hardware implemented program is operable for facilitating the provision of humanitarian aid through the purchase of upgrades to purchasable items. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “recognizing,” “assigning,” “determining,” “presenting,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### 2. Providing Humanitarian Aid Through Upgrades

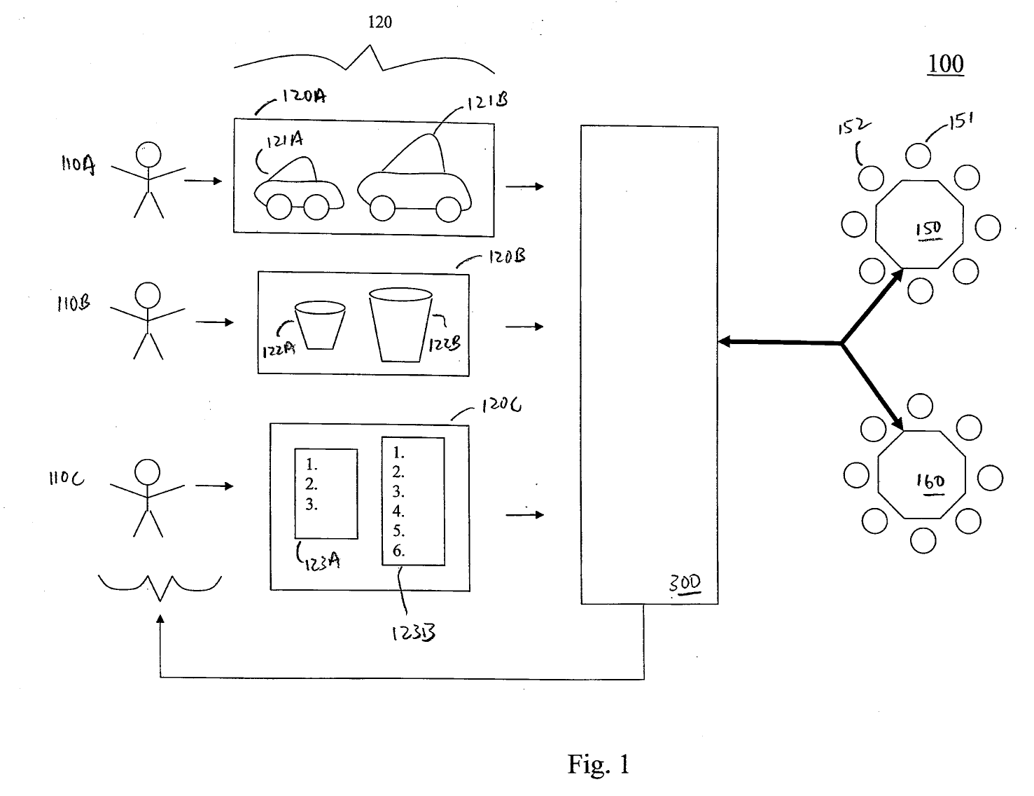

FIG. 1 is an illustration of a network of merchant outlets (e.g., retailers) or distribution avenues in a system 100 that is capable of providing humanitarian aid, in accordance with one embodiment of the present invention. Specifically, system 100 provides for the implementation of humanitarian aid as a direct or indirect result of the purchase of upgrades to items for purchase.

As shown in FIG. 1, system 100 includes a plurality of merchant outlets 120 for providing items for purchase. Each of the merchant outlets provides an avenue for a consumer to purchase an item. For example, one merchant outlet includes a conventional, retail store, in which a transaction completing the purchase of an item occurs mostly at the location of the store. That is, the customer travels to the store, sees or understands the item for purchase, and purchases the item at the store. These stores are situated in various locations, such as in a stand-alone building, a strip mall, a mall, a lot for outdoor display of larger items (e.g., cars, boats, recreation vehicles, farm equipment, etc.), outside venue, etc. Other merchant outlets include other types of stores, such as a warehouse distribution center, restaurant, fast food restaurant, etc. Still other merchant outlets include those effecting electronic commerce, such as sites on the internet offering items for purchase. In addition, other merchant outlets include companies operating out of offices that are offering services, such as tax preparation, attorney services, etc. As can be seen, any merchant outlet suitable for offering an item for purchase is included within the plurality of merchant outlets 120.

As described previously, the term “item” is representative of anything and everything that is purchasable by a consumer, such as one or more goods, one or more services, and a combination of goods and services. Also, it is important to note that the term “consumer” is intended to include individual persons, a group of persons, companies, organizations, or any suitable category that is capable of purchasing the above defined item. In addition, the term “upgrade,” or similar term, is representative of features that are provided in addition to, in substitution of, or any combination of addition and substitution of features to an original item for purchase. As such, an item for purchase is associated with an upgraded item that provides substituted or additional features, or a combination thereof. The features of the upgraded item are associated with a different value, which is referred to as an “upgrade cost” in this Application.

As a representative example, merchant outlet 120A is a car dealership. Specifically, merchant outlet 120A represents the avenue by which a consumer is able to purchase an item, which in this case is a car. As shown, consumer 110A is interested in purchasing a car from merchant outlet 120A. The consumer 110A is offered an item for purchase, car 121A. In addition, consumer 110A is offered an upgrade to the item for purchase, which is included in upgraded car 121B. Car 121B, with the upgrade, is shown larger than car 121A, without the upgrade, to represent the upgraded features provided. It is important to note that the upgrade may or may not be truly representative of an increase in size of car 121A, but is shown merely for illustration purposes. For instance, upgrades may include a better paint job, a higher performance radio, a sports package, a larger body, etc.

In addition, merchant outlet 120B is any retail environment that is offering drinks, or any other item. For instance, merchant outlet 120B may be a fast food restaurant, a convenience store, a movie theater, a sporting venue, etc. As shown, consumer 110B is interested in purchasing a drink (e.g., soft drink) from merchant outlet 120B. The consumer 110B is offered an item for purchase, drink 122A. In addition, consumer 110B is offered an upgrade to the drink 122B, which is included in upgraded drink 122B. Drink 122B, with the upgrade, is shown larger than drink 122A, without the upgrade, to represent the additional features provided. It is important to note that the upgrade may or may not be truly representative of an in increase in size of drink 122A, but is shown merely for illustration purposes. For instance, an upgrade may include an additive to the drink (e.g., supplement, vitamins, energy boost, liquor), additional quantities of drink (e.g., a large drink over a small drink), inclusion of a promotional cup, etc.

Also, merchant outlet 120C is representative of a business that is offering services, such as auto maintenance/repair, construction labor, insurance plans, tax services, mortgage services, etc. As shown, consumer 110C is interested in purchasing services from merchant outlet 120C. The consumer 110C is offered an item for purchase, package of services 123A. The package 123A may include one or more services, such as services 1, 2, and 3. In addition, consumer 110C is offered an upgrade to the package 123A, which is included in upgraded package of services 123B. Package 123B, with the upgrade, is shown larger than package 123A, without the upgrade, to represent the additional features provided. It is important to note that the upgrade may or may not be truly representative of an increase in the number of services originally offered in package 123A, but is shown merely for illustration purposes. For instance, an upgrade may include a package 123B that includes entirely different services from package 123A. This may be the case where a consumer is offered an upgrade to a travel cruise package. The basic package may include a room below decks, and limited entertainment. The upgraded package may include a suite above deck, with a myriad of entertainment opportunities. Also, an upgrade may include a package 123B that may include services provided in addition to or in substitution of the services in package 123A. In one case, package 123A includes services 1-3. As shown in FIG. 1, the upgraded package 123B includes each of the services originally provided, as well as additional services, 4-6, but could easily include any combination of services that is provided in substitution, in addition to the services originally provided, or any combination thereof.

Each of the plurality of merchant outlets 120 is capable of recognizing, notifying, and tracking sales of purchasable items and upgraded items. Specifically, a tracking/notification module at each merchant outlet is capable of recognizing when a purchase of an item has been made by a consumer, and furthermore, when a purchase of an upgraded item has been made by a consumer. For instance, tracking/notification module 125 tracks purchases of upgraded items made at merchant outlet 120A, tracking/notification module 127 tracks purchases of upgraded items made at merchant outlet 120B, and tracking/notification module 129 tracks purchases of upgraded items made at merchant outlet 120C.

Additionally, notification of an occurrence of these purchases, and more specifically, of a purchase of an upgraded item is provided by the corresponding tracking/notification module (e.g., module 125, 127, or 129). Specifically, notification of an upgraded purchase is sent from a corresponding tracking/notification module to contribution distributor 300.

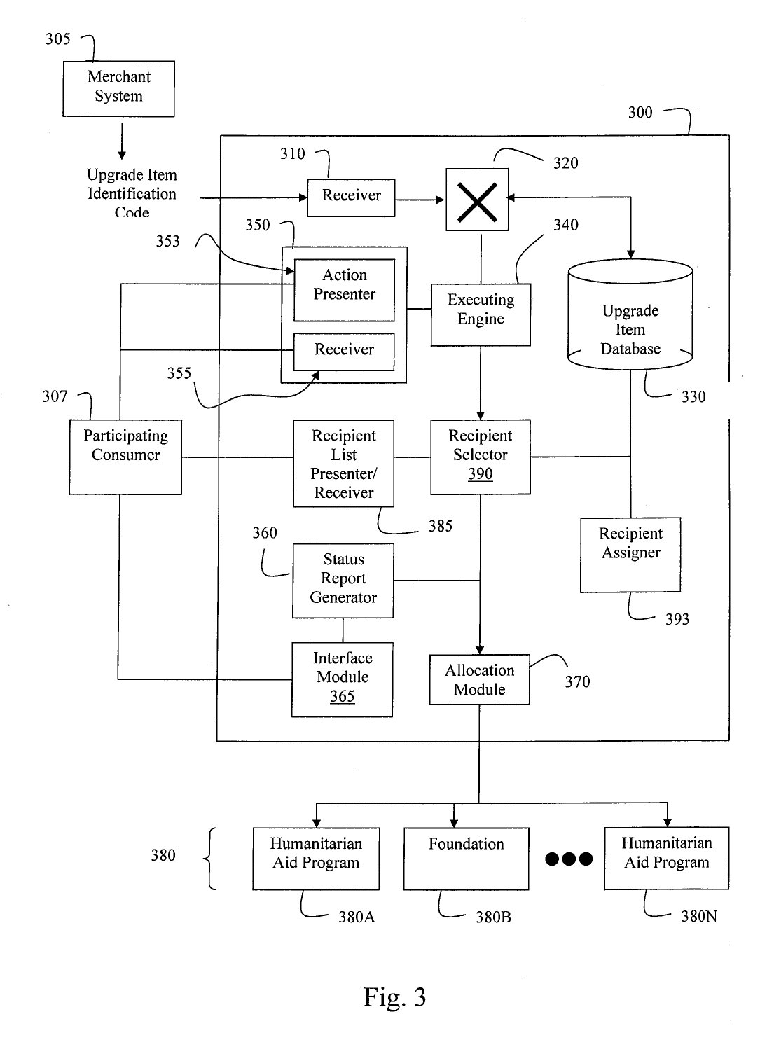

As will be more fully described below in reference to FIG. 3, contribution distributor 300 is able to allocate resources or direct instructions to one or more humanitarian aid programs (e.g., programs 150 and 160). For instance, upon notification of a sale of an upgraded item, contribution distributor 300 is able to appropriately allocate funds or appropriately provide instructions directed to the provision of humanitarian aid.

The humanitarian aid programs 150 and 160 shown in FIG. 1 are representative of any number of programs that provide humanitarian aid. Although only two programs are shown, embodiments of the present invention are well suited to supporting any number of humanitarian aid programs (e.g., one or more). Also, it is envisioned that a humanitarian aid program may be a charitable foundation through which humanitarian aid is distributed through one or more humanitarian aid programs. In addition, a humanitarian aid program may be specific to a particular region, village, sponsored individual, and may include one or more specific projects offering defined humanitarian aid. In that case, upon the purchase of an upgraded item, humanitarian aid is provided for that region, village, or sponsored individual.

For example, humanitarian aid program 150 is representative of any organization, program, activity, project, or any other suitable end destination that is capable of providing humanitarian aid. As described before, program 150 may be a charitable foundation, which is responsible for any number of derivative projects. For instance, the charitable foundation may be further defined by a specific aid project 151, such as sponsorship of a village in South America. In addition, the charitable foundation may be further defined by any number of specific tasks or actions (e.g., action 152) that provides humanitarian aid in a defined manner. In one case, the action may be to provide funds to inoculate one child in a town in North America.

As such, once contribution distributor 300 recognizes that a purchase has been made of the upgraded item 120B, the car with upgrades, further steps are taken to provide humanitarian aid that is associated with that purchase. For instance, in one case, funds are allocated appropriately to a humanitarian aid program (e.g., program 150) that is associated with the upgraded item. In another case, instructions are provided to the program for purposes of achieving a directed action for providing humanitarian aid. These instructions may include the allocation of funds specifically tied to achieving the directed action, instructions to perform the directed action, etc.

Contribution distributor 300 may be located remotely from the plurality of merchant outlets, in order to receive notifications of the purchase of upgraded items from each of the plurality of merchant outlets 120. In addition, the contribution distributor 300 may be located at one of the plurality of merchant outlets 120 to receive notifications of the purchase of upgraded items from each merchant outlet, including remote merchant outlets. In still another case, the contribution distributor 300 is dedicated to a particular merchant outlet. As such, contribution distributor 300 would be located at a specific merchant outlet to provide for humanitarian aid in association with a purchase of an upgraded item at that specific merchant outlet.

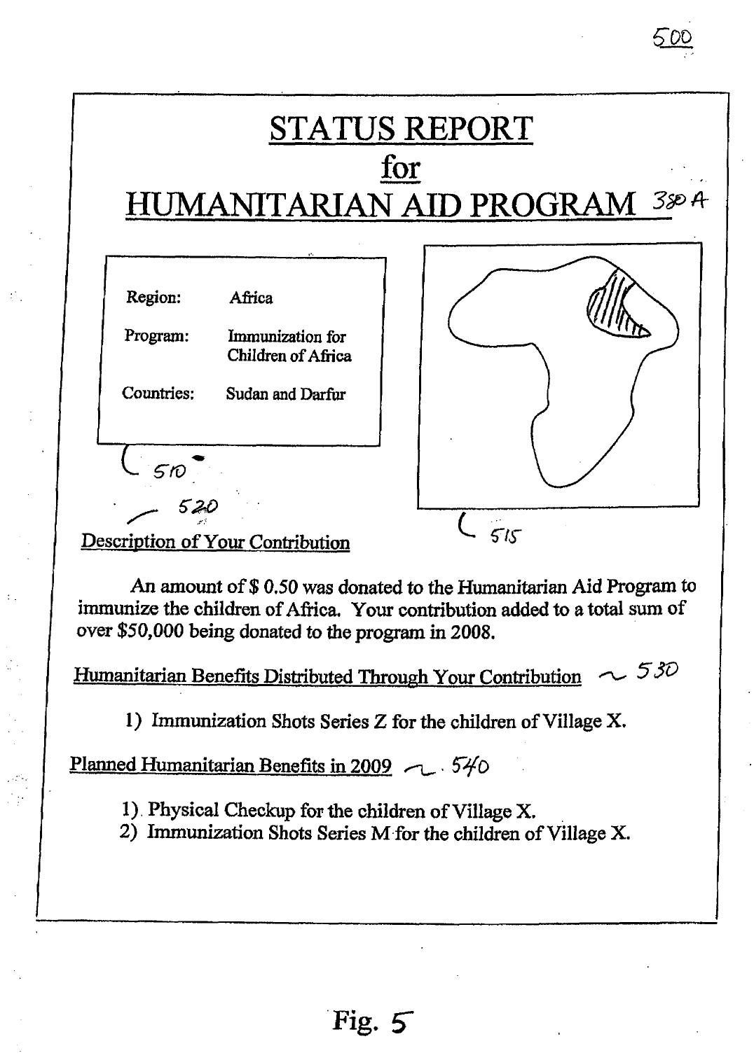

As shown in FIG. 1, contribution distributor 300 is also able to provide status reports back to consumers. As will be described more fully below in relation to FIG. 5, contribution distributor 300 is able to receive status information from each of the humanitarian aid projects, generate a status report for each humanitarian aid project, and provide access to the reports to the consumers making the purchases of upgraded items.

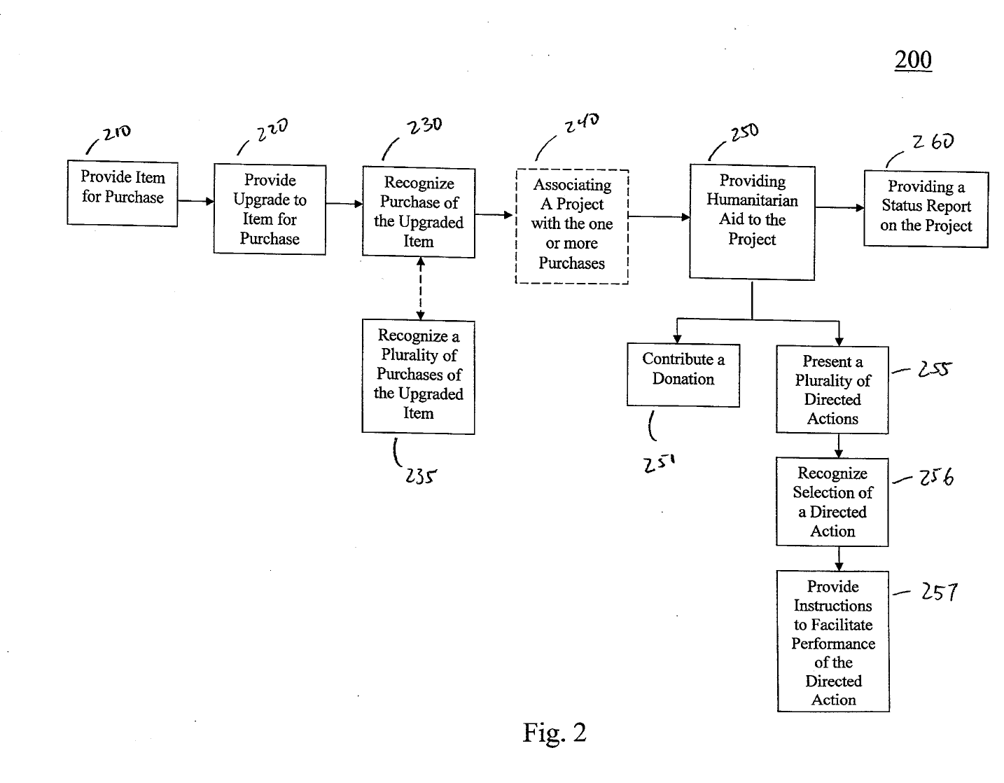

FIG. 2 is flow diagram illustrating a method for providing humanitarian aid through the purchase of upgrades to purchasable items, in accordance with one embodiment of the present invention. The method is implemented within the system 100 of FIG. 1, in one embodiment.

At 210, an item is provided for purchase at a first price. As described previously, the item includes anything and everything that can be purchased by a consumer, to include goods, services, or a combination of goods and services, as examples. For instance, the item may be goods (e.g., an automobile, drink, etc.), services (an insurance plan, a maintenance service plan for an automobile, professional service, labor services, etc.), a package of goods, a package of services, a package of a combination of goods and services, etc.

As previously described, the item is provided by any merchant outlet or distribution point suitable for effecting a transaction for the purchase of the item. For instance, the merchant outlet or distribution point may be a retail store, a movie theater, an internet web site, a warehouse, an office or business providing services, a travel service, etc.

At 220, an upgrade to the item is provided. That is, an upgraded item, which includes the upgrade, is provided also for purchase at a second price. The upgraded item is generally perceived to have upgrades to the original item. That is, the upgraded item is related to the original item, such that additional features may be provided in addition to the features in the original item, new features may be substituted for features in the original item, or a combination of additional or substituted features may be included in the upgraded item. As such, the upgraded item may or may not include features that were included in the original item. For example, one item may be a basic model of a car and its corresponding upgraded item may be a higher model of the car that includes various upgrades (e.g., power windows).

The original item is provided at a first price, or baseline price. The upgraded item is provided at second price that may be different than the first price. Specifically, the upgraded item is provided at a purchase price that includes an upgrade cost. Typically, the purchase price of the upgraded item is more than price of the original item, such that the upgrade cost is positive. In other cases, the purchase price of the upgraded item is less than the price of the original item, such that the upgrade cost is negative. For example, promotional programs may discount an upgraded item in an effort to stimulate sales. In still other cases, the purchase price of the upgraded item is equal to the price of the original item, such that the upgrade cost is zero. As such, the purchase price of the upgraded item depends on the upgrade cost.

At 230, a single purchase of an upgraded item is recognized. The purchase is made at a corresponding merchant outlet. Similarly, at 235, a plurality of purchases of the upgraded item is recognized. That is, purchases of the upgraded item are made at one or more merchant outlets. As such, one or more purchases of the upgraded item is recognized, such that it is recognized each time when the upgraded item is purchased by a corresponding consumer at a corresponding merchant outlet. A purchase of only the original item is not recognized, and is not associated with providing humanitarian aid.

For example, returning back to FIG. 1, a tracking/notification module at a corresponding merchant outlet or contribution distributor 300 is able to track and recognize when a purchase of an upgraded item has been made. Recognition can occur automatically or through user input. For instance, the tracking/notification module is able to automatically recognize when a purchase of the upgraded item has been made by tracking all sales at the corresponding merchant outlet. In another case, through user input indicating a sale of the upgraded item, the tracking/notification module is able to recognize a purchase of the upgraded item. Thereafter, notification of the purchase of the upgraded item is sent from the tracking/notification module of a corresponding merchant outlet, that is associated with the sale of the upgraded item, to the contribution distributor 300 for purposes of providing humanitarian aid.

At 240, optionally, a humanitarian aid program is associated with the one or more purchases of the upgraded item. In one case, the program may be preliminarily associated with or assigned to the upgraded item, before any purchase is made. For instance, in one embodiment, each purchase of the upgraded item, no matter from which merchant outlet the purchase was made, is associated, at least initially, with the predefined humanitarian aid program. Also, the program may be dynamically assigned to the purchase of the upgraded item, at the time of the one or more purchases. For instance, contribution distributor 300 may assign the humanitarian aid program to be associated with a group of one or more purchases of the upgraded item. Further, the program may be selectable by a corresponding consumer to be the recipient of a donation or instruction for purposes of providing humanitarian aid. That is, at the time of the purchase of the upgraded item, the consumer may select a program from a plurality of programs. The selected program is then associated with the purchase of the upgraded item by the consumer for purposes of providing humanitarian aid. In still another case, the humanitarian aid program may be selectable by other persons or entities, such as the company associated with the merchant outlet where the purchase of the upgraded item was made.

In one case, the association between a humanitarian aid program and the purchase of an upgraded item is promoted. Specifically, in an effort to stimulate the purchase of the upgraded item, the consumer is notified that in conjunction with the purchase, humanitarian aid is provided. For example, the consumer is notified that a portion of the upgrade cost or sale of the upgraded item will be donated to a humanitarian aid program. To magnify the effect of the promotion, only certain upgraded items may be associated with a humanitarian aid benefit.

Because of the benefit of providing humanitarian aid, the consumer may have additional motivation to purchase the upgraded item. For instance, the consumer may personally feel better, or the consumer may give the impression of being generous in front of others when making the purchase of the upgraded item. As such, the consumer not only gains a material benefit from the purchase of the upgraded item, but also an emotional benefit knowing that the purchase is directly related to the provision of humanitarian aid, or the benefit of being perceived in high esteem by his or her peers.

At 250, in association with one or more purchases of the upgraded item, humanitarian aid is provided. For instance, as previously described, in one case at 251, a portion of the upgrade cost or purchase price of each upgraded item is donated to a humanitarian aid program. As an example, instructions are sent to provide funds matching the donation to an account held for the humanitarian aid program. In another case, a donation that is based on the cumulative upgrade cost of a group of purchases of the upgraded item, or the cumulative purchase price of a group of purchases of the upgraded item, is made to a humanitarian aid project.

It is important to note that the donation is tied directly to the purchase of the upgraded item by the consumer, in one embodiment. That is, no other purchases by the consumer is taken into consideration when calculating the amount for the donation. Also, the consumer is not making a straight donation, and one not associated with any purchase. In one instance, the donation is a percentage of the upgrade cost for the upgraded item. In another instance, the donation is a percentage of the purchase price for the upgraded item. In still other cases, the donation is a predetermined amount.

In another embodiment, at 255, 256, and 257, instructions for performance of a specific action are provided for purposes of providing humanitarian aid. Specifically, at 255, a plurality of directed actions is provided to a consumer for selection. The consumer has already made or is contemplating a purchase of the upgraded item. Presentation of the directed actions and selection of a selected action need not occur simultaneously with the purchase transaction. For instance, the consumer may access the plurality of directed actions through some portal (e.g., internet or phone) at a time that is after the purchase transaction, and at a location (e.g., home, kiosk at the merchant outlet, etc.) that is different than where the purchase transaction was made.

While the present invention provides for selection of a directed action by the consumer, other embodiments are well suited to other entities making the selection of the directed action. For instance, the company associated with the merchant outlet where the purchase of the upgraded item was made may make the selection of the directed action.

At 256, a selected directed action is recognized. Specifically, a consumer is able to select a directed action from the plurality of directed actions. The selected directed action is recognized, for example by contribution distributor 300 for purposes of providing humanitarian aid. For instance, a directed action may provide immunization shots for a particular child in a particular village. The immunization shots are in association with a project that is providing immunization and other health care to the village. As such, at 257, as determined by the selection by the consumer, instructions are provided to facilitate giving immunization shots to the child. That is, certain actions are performed to facilitate performance of the directed action. As an example, if the directed action calls for giving immunization shots to a child, a donation may be contributed to a program giving health care to a village native to the child. In that way, the donation is contributed to the program for purposes of achieving the selected directed action, either indirectly or directly.

It is important to note that facilitation of the directed action need not necessarily result directly in implementation of the directed action. That is, selection of the directed action need only result in some action that can be associated with the directed action, or that leads towards performance of that action. For example, donation of funds to a charitable project will facilitate performance of a directed action.

Further, it is important to note that implementation of a directed action need not necessarily be a direct result of the purchase of the upgraded item. For instance, in the above immunization example, a child that seemingly is the recipient of a directed action may receive immunization shots even though no consumer has specifically directed that action. That is, the directed action may be related to an immunization program providing immunization shots to an entire village, that has been or will be funded. As such, all the children in the village are to be provided with immunization shots, irrespective of the selection of a directed action towards a particular child.

Of course, in other embodiments, selection of a directed action results in that action being performed. For instance, if the directed action calls for giving immunization shots to a particular child, shots are given as a result of the selection of that directed action.

At 260, a status report is provided regarding the humanitarian aid project. As such, as consumers make purchases of upgraded items, they become aware of the providing of humanitarian aid through a corresponding humanitarian aid program. The consumer is able to gain access to the status report to gain a further understanding and appreciation of the efforts of the humanitarian aid program, as supported, in part, through the generosity of the consumer.

For instance, in one embodiment, an identifier (e.g., number or name) is assigned to a purchase of the upgraded item by a consumer. The identifier is given to the consumer. The identifier identifies the program that is directly associated with the purchase of the upgraded item. The identifier can also identify the transaction associated with the purchase of the upgraded item by the consumer. As such, the identifier can be used by the consumer to determine the proper humanitarian aid program that benefits from the purchase of the upgraded item by the consumer.

In one case, the consumer presents the identifier to contribution distributor 300 for purposes of accessing a status report. Specifically, contribution distributor 300 is able to cross-reference the identifier with the humanitarian aid program associated with the corresponding purchase of an upgraded item. Once the program is determined from the identifier, contribution distributor 300 is also able to identify and access the status report for that program. Thereafter, contribution distributor 300 is able to make the status report available to the consumer. For instance, the status report is accessible by the consumer over a communication network (e.g., internet).

The method of FIG. 2 is implementable within a system for providing humanitarian aid, in accordance with one embodiment of the present invention. For instance, the system includes means for providing an item for purchase at a first price. A merchant provides the conduit for presenting an item for purchase to consumers. In other cases, an online merchant is capable of presenting an item for purchase. The system also includes means for providing an upgrade to the item, as an upgraded item. Typically, the item is offered at a first price, while the upgraded item is offered at a second price that includes an upgrade cost. Upgrades offer different variations to the basic item, and may provide additional features, substituted features, or a combination of additional or substituted features. The system also includes means for recognizing a purchase of the upgraded item. For instance, a scanning module that recognizes one of any number of bar coding systems can be used to both identify and track purchases of upgraded items. Still other means are contemplated, such as automatic reporting mechanisms, manual reporting mechanisms, etc. The system includes means for providing humanitarian aid based on the purchase of the upgraded item. That is, a purchase of the upgraded item directly or indirectly results in the provision of humanitarian aid. In one instance, a donation is given to a humanitarian aid program that will provide the humanitarian aid.

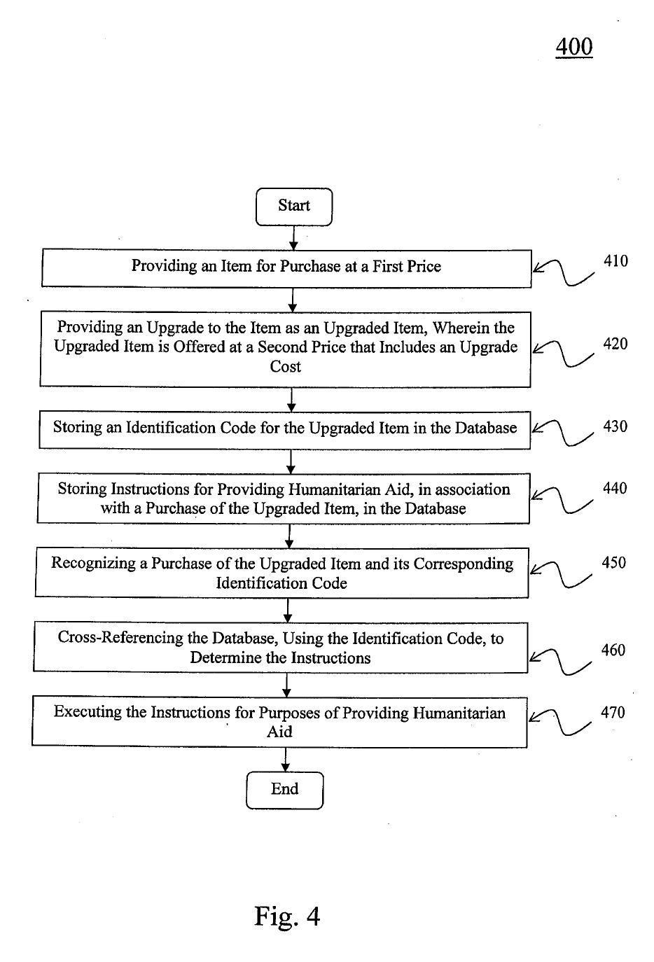

FIGS. 3 and 4 in combination illustrate a method and system for providing humanitarian aid, in accordance with embodiments of the present invention. FIG. 3 illustrates a contribution distributor 300, first shown in FIG. 1, and FIG. 4 illustrates a method for providing humanitarian aid, as implemented, in part, through contribution distributor 300, in accordance with one embodiment of the present invention.

Turning now to FIG. 3, a block diagram of a contribution distributor 300 is shown that is capable of facilitating the provision of humanitarian aid with the purchase of an upgraded item, in accordance with one embodiment of the present invention. Contribution distributor 300 may be consolidated into a single unit, as shown in FIG. 3, or distributed throughout a communication network. In either case, the modules of contribution distributor 300 are capable of communicating with each other to facilitate the provision of humanitarian aid. As such, contribution distributor 300 provides the control center for the distribution of instructions or donations to programs for purposes of providing humanitarian aid as a result of a purchase of an upgraded item.

A merchant system 305 communicates with the contribution distributor 300. For instance, tracking/notification modules 125, 127 and 129 may act as the merchant system 305 to communicate with the contribution distributor. An upgraded item identification code is communicated between the merchant system 305 and the contribution distributor 300. Specifically, as provided in 450 of FIG. 4, a purchase of the upgraded item is recognized, along with its corresponding item identification code. As such, the merchant system 305 is capable of providing notification of when an upgraded item has been purchased by sending the upgraded item identification code to the contribution distributor 300. Other information related to the purchase may also be sent to the contribution distributor, such as an associated recipient, a donation amount, the purchaser, a purchase transaction identification code, etc.

As described in reference to 410 of FIG. 4, the merchant provides an item for purchase at a first price. The item can include goods, services, or a combination of goods and services, as examples. In addition, at 420 of FIG. 4, an upgrade to the item is also provided. The upgraded item, which includes the upgrade, is provided for purchase at a second price. Upgrades may include additional features to the original item, new features substituted for those in the original item, or a combination of additional or substituted features may be included in the upgraded item.

The original item is provided at a first price, or baseline price. The upgraded item is provided at second price that may be different than the first price. Specifically, the upgraded item is provided at a purchase price that includes an upgrade cost. Typically, the purchase price of the upgraded item is more than price of the original item, such that the upgrade cost is positive.

As shown in FIG. 3, contribution distributor 300 includes a receiver 310 for receiving notifications from various merchant outlets of the purchase of upgraded items. Specifically, as previously described, with each purchase of an upgraded item, a notification is sent by the merchant system 305 to the contribution distributor 300 for purposes of providing humanitarian aid. Here, the contribution distributor 300 recognizes a purchase of the upgraded item, as also provided in 450 of FIG. 4.

Once notification is received, a comparator 320 parses out information to determine the upgraded item. Specifically, contribution distributor 300 may receive a plurality of notifications providing notification of the purchase of a plurality of upgraded items. As such, comparator 320 is able to determine which upgraded item was purchased in relation to a corresponding notification.

A plurality of identification codes is stored in an upgraded item database 330 for a plurality of upgraded items, as provided. That is, for each upgraded item provided for purchase in a program providing humanitarian aid, that upgraded item is identifiable using a corresponding identification code. Database 330 is fully referenced using the identification code, or any other appropriate identifier. As such, additional information related to an upgraded item is referenced using the corresponding identification code. For instance, other information may include a donation amount for a donation, a recipient to receive the donation, etc.

Also included in the database are instructions for providing humanitarian aid. For instance, at 440 of FIG. 4, instructions for providing humanitarian aid are stored in association with corresponding upgraded items. As such, with a purchase of an upgraded item, the database provides, as accessed by a corresponding upgraded item identification code, instructions for providing humanitarian aid, as described in 460 of FIG. 4. Specifically, comparator 320 is capable of cross-referencing database 330, using the identification code, to determine the corresponding instructions for providing humanitarian aid in association with the purchase of a corresponding upgraded item. Instructions may provide for the distribution of funds as part of a donation to an identified recipient. Other instructions may provide for directed actions that are identified to be performed by a humanitarian aid program. Still other types of instructions are envisioned for providing humanitarian aid.

As shown in FIG. 4, executing engine 340 is included in contribution distributor 300, and is responsible for effecting the provision of humanitarian aid. Specifically, as provided in 470 of FIG. 4, executing engine 340 executes the instructions for purposes of providing humanitarian aid.

In one embodiment, the instructions provide for the distribution of a donation to a recipient (e.g., a humanitarian aid program). These instructions may be stored in database 330. The amount of the donation can be determined through any number of means, to include a predefined portion of the upgrade cost, a predefined portion of the purchase price of the upgraded item, a percentage of the upgrade cost, a percentage of the purchase prices of the upgraded item, a set amount for the donation, etc. As such, the instructions may provide for funds matching the donation to be deposited in an account held for or by the recipient.

In another embodiment, the executing engine 340 is capable of further determining instructions to be performed. That is, the instructions stored in database 330 directs executing engine 340 to determine additional instructions for providing humanitarian aid. For instance, a directed action may be associated with the purchase of the upgraded item. Additional instructions as executed by engine 340 may provide for selection of a directed action by a participating consumer 307 who makes the purchase of the upgraded item, or one who is associated with the consumer making the purchase of the upgraded item, or some other related party (e.g., the corresponding merchant outlet), who is associated with the purchase of the upgraded item.

As such, interface module 350 includes an action presenter 353 and receiver 355. Action presenter 353, as directed by executing engine 340, is able to present to a user interface, associated with a participating consumer 307, a plurality of directed actions for selection by the consumer. In addition, receiver 355 is able to receive selection of a directed action by the user interface associated with the participating consumer 307, which is then relayed back to executing engine 340. As such, the contribution distributor 300 is capable of interfacing with the consumer through the presentation of a plurality of directed actions for selection by the consumer, as well as receiving selection of a directed action. In that manner, contribution distributor 300 is able to relate the purchase of an upgraded item by the consumer to a directed action as selected by the consumer, or some other related party.

Contribution selector 300 also includes a recipient selector 390, which associates a recipient (e.g., humanitarian aid program) with the purchased upgraded item. As described previously, the recipient may be a humanitarian aid program (e.g., program 380A, 380N, etc.), or a foundation that is dedicated to providing aid through various humanitarian aid programs. For instance, as shown in FIG. 3, a plurality of recipients 380 is able to provide humanitarian aid. For purposes of illustration, a recipient is generally referenced as a humanitarian aid program in the present Application, but could include foundations, humanitarian aid programs, and other types of programs that are capable of distributing humanitarian aid.

As previously described, there are numerous ways to associate a humanitarian aid program with a particular purchase of an upgraded item. For instance, selector 390 is able to determine if a humanitarian aid program is automatically associated with the upgraded item. Specifically, recipient assigner 393 is coupled to executing engine 340 and database 330 and assigns a recipient to the upgraded item, to which the instructions are directed. That is, recipient assigner 393 has previously assigned a recipient to the upgraded item. As such, recipient selector 390 is able to select the proper recipient by cross-referencing database 330. For instance, the information is accessible using the corresponding identification code. In that case, any time the upgraded item is purchased, humanitarian aid is provided through the associated program. As such, database 330 provides for predetermined upgraded item/recipient associations, or instructions for determining the proper recipient, or recipients.

In addition, selector 390 may dynamically select a recipient to be associated with the purchase of the upgraded item. In one case, the recipient assigner 393 dynamically assigns the recipient to the purchase, and communicates that assignment to the recipient selector 390. In that case, the purchase is not immediately associated with any humanitarian aid program, but an association is made later by recipient selector 390, or recipient assigner 393. In some cases, the association is randomly selected. In other cases, instructions for dynamic selection are provided in database 330. In still other cases, other means for associating the recipient are contemplated.

Also, recipient selector 390 may recognize the selection of a humanitarian aid program to be associated with the purchase. That is, instead of having a predetermined recipient for effecting the distribution of humanitarian aid, a participating consumer 307 may provide instructions for the selection of a recipient. In this case, database 330 may provide instructions for effecting consumer selection. For instance, one or more recipients may be presented by recipient list presentor/receiver 385 to the user interface associated with participating consumer 307. The list is presented for selection by the participating consumer 307. Also, a recipient list presentor/receiver is configured to receive a selection of a recipient by the user interface associated with participating consumer 307.

In one embodiment, the selection of a recipient is performed at the time of the purchase of the sponsored items. For instance, the consumer at the time of purchase, or the merchant outlet during the course of the transaction, may be presented with a list of recipients for selection at the time of the purchase of the upgraded item. In turn, the participating consumer 307 may select a recipient (e.g., humanitarian aid program) to be associated with the purchase of the upgraded item. The selected recipient is then associated with the purchase of the upgraded item for purposes of providing humanitarian aid. In one case, the notification provided by the merchant system 305 may include the selected recipient that is associated with the purchase of the upgraded item. The selected recipient is then stored in database 330.

As shown in FIG. 3, an allocation module 370 is capable of distributing funds or instructions to the appropriate recipient (one or more of recipients 380A-N). For instance, in the case where a donation is given, allocation module 370 is able to distribute a donation to the proper recipient. More particularly, if the donation is made in terms of funds, allocation module 370 allocates funds to the associated humanitarian aid program as the recipient (e.g., program 380A) for purposes of providing humanitarian aid. For instance, funds matching the donation are deposited to the account held for or by the humanitarian program 380A. If there are multiple recipients, allocation module 370 is capable of distributing donations to the proper recipients.

In addition, the allocation module 370 is also capable of providing specific instruction that authorizes performance of a directed action to the associated humanitarian aid program. For instance, if the selected directed action is to provide immunization shots for a particular child, the allocation module 370 is capable of authorizing giving shots to the child through the associated program. In one implementation, in addition with the instruction, the allocation module 370 is capable of distributing funds, as a donation, towards achieving implementation of the directed action to the associated humanitarian aid program which performs the directed action.

Contribution distributor 300 also includes a report generator 360 that is capable of generating status reports for one or more humanitarian aid programs. Specifically, the report generator 360 receives pertinent information from each of the programs, and generates a separate report for each program that receives donations or instructions to perform directed actions that is associated with purchases of upgraded items. As such, report generator 360 is able to collect information and present the information to interested consumers who purchased the upgraded items. A more detailed discussion of an exemplary report is provided in relation to FIG. 5.

Interface module 365 provides an avenue for consumers to access the reports generated by the report generator 360. As examples, the consumer 307 may access the interface module 365 from various locations, including a home computer, a mobile phone, a kiosk computer located at the merchant outlet from which a purchase was made, etc. As described previously, a consumer may present a transaction identifier to the interface module 365. The transaction identifier is given to the consumer in association with the transaction involving the purchase of the upgraded item. As such, the transaction identifier identifies the associated humanitarian aid project that corresponds to a purchase of an upgraded item by the requesting consumer. Through the identifier, the proper report may be accessed, and presented to the requesting consumer via the interface module 365.

As such, as consumers make purchases of upgraded items, they can become more aware of the impact they have in providing humanitarian aid through a corresponding humanitarian aid program just by making a purchase. That is, the requesting consumer 307 is able to gain access to the status report to gain a further understanding and appreciation of the humanitarian aid program, as supported, in part, through the decision of the consumer to purchase the upgraded item.

FIG. 5 is an illustration of a status report 500 providing information related to a particular humanitarian aid program (e.g., Program 380A). As described previously, the status report 500 is managed and generated by the report generator 360 of the contribution distributor 300. Access to the status report 500 is available through a server via a communication network (e.g., internet), in one embodiment. As such, status report 500 is accessible through the interface module 365 of the contribution distributor 300 by a consumer whose purchase of an upgraded item resulted in the provision of humanitarian aid through Program 380A. The status report 500 may be accessed by presenting a transaction identifier that associates the purchase transaction with a corresponding humanitarian aid program. Other embodiments envision varying avenues of distribution (e.g., mail, phone, text message, etc.).

Status report 500 is intended to provide an exemplary report for a corresponding humanitarian aid program (e.g., program 380A). Status report 500 may be configured to provide any type of information in whatever format. For instance, the information may be presented via text, graphics, audio, or any combination of these formats.

As shown in FIG. 5, Program 380A has chosen Africa as a region of focus, as is described in information block 510. Specifically, Program 380A is devoted to providing immunization to the children of Africa. Rather than taking on the whole continent, Program 380A is focusing its immunization efforts to the country of Sudan, and more particularly, in the western Darfur region.

At block 515, graphical or video images may be presented to the consumer showing the implementation of humanitarian aid. For instance, video images of children receiving immunization shots may be displayed in block 515. Once the video is completed block 515 may return to the static display highlighting Sudan, and its western region, Darfur, that benefits from the consumer's purchase.

Under heading 520, the consumer is provided with a description of his or her contribution. As an example, a donation in the amount of fifty cents has been made to Program 380A. This donation was made in response to the purchase of an upgraded item (e.g., the purchase of a super-large drink item, upgraded from a large drink). While the specific donation is relatively small, report 500 also provides information regarding the total sum donated to Program 380A as a result of consumers purchasing corresponding upgraded items (e.g., fifty-thousand in 2008). Of course, donations may range from under a dollar to those over a dollar, depending on the corresponding upgraded item that was purchased. An upgraded item relating in the purchase of a car with upgraded features would probably result in a donation to a humanitarian aid program approaching or exceeding one-hundred dollars.

Under heading 530, the consumer is provided with a description of specific actions resulting from his or her purchase of an upgraded item. For instance, the children of Village X received immunization shots from Series Z, as a result of the consumer's purchase of the upgraded item. It is understood that the purchase of the upgraded item facilitates the implementation of the actions listed under heading 530. That is, a single purchase supports the implementation of the actions, while a group of purchases of the upgraded item may directly provide enough funds for the completion of the actions.

Under heading 540, a listing is provided of upcoming humanitarian aid to be received through the continued sponsorship of Program 380A. In that manner, the consumer gains a sense of responsibility towards Program 380A. This may result in the consumer providing further support of Program 380A through repeated purchases of the upgraded item.

For instance, as shown under heading 540, planned distribution of benefits includes additional health programs for Village X. In one case, a physical checkup of the children of Village X is planned for the next year. In addition, additional immunization shots from Series M are planned to be given to the children of Village X in the next year.

Status report 500 may include other information, not shown. For instance, status report 500 may also include a listing of all the benefits received by a particular village, or individual (e.g., a child recipient). In this manner, the consumer is able to view this information and gain a sense of his or her involvement in the well being of a village, or specific individuals for that village.

While the methods of embodiments illustrated in flow charts 2 and 4 show specific sequences and quantity of operations, the present invention is suitable to alternative embodiments. For example, not all the operations provided for in the methods presented above are required for the present invention. Furthermore, additional operations can be added to the operations presented in the present embodiments. Likewise the sequences of operations can be modified depending upon the application.

A method and system for providing humanitarian aid through the purchase of upgrades of items for purchase are thus described. While the invention has been illustrated and described by means of specific embodiments, it is to be understood that numerous changes and modifications may be made therein without departing from the sprit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A system for providing humanitarian aid, comprising:
means for providing an item for purchase at a first price;
means for providing an upgrade to said item as an upgraded item, wherein said upgraded item is offered at a second price that includes an upgrade cost;
means for recognizing a purchase of said upgraded item; and
means for providing humanitarian aid based on said purchase.

2. A method for providing humanitarian aid, comprising:
providing an item for purchase at a first price;
providing an upgrade to said item as an upgraded item, wherein said upgraded item is offered at a second price that includes an upgrade cost;
recognizing a purchase of said upgraded item; and
in association with said purchase, providing humanitarian aid.

3. The method of claim 2, further comprising:
associating a humanitarian aid program with said purchase; and
contributing a donation based on said second price to said humanitarian aid program.

4. The method of claim 2, further comprising:
promoting an association between said humanitarian aid program and said donation to stimulate said purchase.

5. A method for providing humanitarian aid, comprising:
providing an item for purchase at a first price;
providing an upgrade to said item as an upgraded item, wherein said upgraded item is offered at a second price that includes an upgrade cost;
storing an identification code for said upgraded item in a database;
storing instructions for providing humanitarian aid, in association with a purchase of said upgraded item, in said database;
recognizing a purchase of said upgraded item and its corresponding identification code;
cross-referencing said database, using said identification code, to determine said instructions; and
executing said instructions for purposes of providing humanitarian aid.

6. The method of claim 5, further comprising:
assigning a recipient that is associated with said upgraded item;
storing a recipient identification code associated with said recipient for said item in said database;
cross-referencing said database, using said identification code, to determine said recipient; and
wherein said executing instructions comprises executing said instructions as directed towards said recipient for purposes of providing humanitarian aid.

7. The method of claim 6, wherein said executing said instructions further comprises:
accessing a donation amount associated with said upgraded item that is stored in said first database, wherein said donation amount is associated with a donation; and
contributing said donation to said recipient for purposes of providing humanitarian aid.

8. The method of claim 6, wherein said assigning a recipient comprises:
presenting a plurality of recipients, to include said recipient, to a user interface associated with a consumer making said purchase of said upgraded item; and
receiving a selection of said recipient from said user interface.

9. The method of claim 5, wherein said recognizing a purchase comprises:
receiving notification of said purchase from a merchant.

10. The method of claim 6, wherein said recipient comprises a humanitarian aid program.

11. The method of claim 6, wherein said recipient comprises a foundation associated with a plurality of humanitarian aid programs.

12. The method of claim 6, wherein said executing instructions comprises:
presenting a plurality of directed actions for execution by said recipient to a user interface associated with a consumer making said purchase;
receiving selection of a selected directed action from said user interface; and
contributing a donation to said recipient for purposes of achieving said selected directed action.

13. The method of claim 6, further comprising:
assigning a purchasing identifier to said purchase that is communicated to a consumer making said purchase;
generating said status report that is associated with said recipient; and
providing access to said status report over a communication network in response to a request for said status report including said purchasing identifier.

14. The method of claim 5, wherein said providing an item comprises:
providing said item for purchase, wherein said item is taken from a group consisting essentially of:
a good;
a service;
a package including a combination taken from goods and services.

15. A system for processing transactions related to providing humanitarian aid, comprising:
a database for storing a plurality of identification codes for a plurality of upgraded items for purchase, and for storing instructions providing humanitarian aid in association with a purchase of a corresponding upgraded item;
a receiver for registering purchases of at least one purchase of an upgraded item that includes an identification code for said upgraded item, wherein said upgraded item is an upgrade to an item provided for purchase at a first price, and wherein a purchase price of said upgraded item includes an upgrade cost;
a comparator coupled to said receiver and said database for cross-referencing said database, using said identification code, to determine said instructions for said at least one purchase; and
an executing engine coupled to said comparator for executing said instructions for purposes of providing humanitarian aid in association with said at least one purchase.

16. The system of claim 15, further comprising:
an assigning module coupled to said executing engine for assigning a recipient to said upgraded item and to which said instructions are directed, wherein a recipient identification code associated with said recipient and said upgraded item are stored in said database; and
a recipient selector coupled to said executing engine for associating said recipient with said upgraded item by cross-referencing said database, using said identification code in association with said at least one purchase.

17. The system of claim 16, wherein said instructions comprises a donation amount associated with a donation, and wherein said executor further comprises:
an allocation module coupled to said executing engine for determining said donation amount and for contributing said donation to said recipient for purposes of providing humanitarian aid.

18. The system of claim 17, wherein said allocation module sends instructions to provide funds matching said donation to an account held for said recipient.

19. The system of claim 16, further comprising:
a presenter coupled to said executing engine for presenting a plurality of directed actions to a user interface associated with a consumer making said purchase;
a second receiver coupled to said executing engine for receiving selection of a selected directed action from said user interface for execution by said executor in executing said instructions in response to said at least one purchase of said upgraded item.

20. The system of claim 19, further comprising an allocation module coupled to said executing engine for contributing a donation to a humanitarian aid program for purposes of achieving said selected directed action.

21. The system of claim 16, wherein said assigning module comprises:
a presenter coupled to said recipient selector presenting a plurality of recipients, to include said recipient, to a user interface associated with a consumer making said purchase of said upgraded item (wherein said instructions say look to a selection by consumer); and
a second receiver coupled to said recipient selector for receiving a selection of said recipient from said user interface.

22. The system of claim 15, further comprising:
a report generator coupled to said executing engine for generating a status report of said recipient; and
an interface module coupled to said report generator for providing access to said status report over a communication network in response to a request for said status report including a purchasing identifier that is assigned to said purchase and communicated to a consumer making a purchase of said upgraded item.

23. The system of claim 15, wherein said recipient comprises a humanitarian aid program.
